(19) United States
(12) Patent Application Publication
(10) Pub. No.: US 2009/0295733 A1
(43) Pub. Date: Dec. 3, 2009

(54) ERGONOMIC KEYBOARD SYSTEMS, COMPONENTS AND METHODS

(76) Inventor: Scott L. Stenbroten, Madison, WI (US)

Correspondence Address: LATHROP & CLARK LLP, 740 REGENT STREET SUITE 400, P.O. BOX 1507, MADISON, WI, 537011507, US

(21) Appl. No.: 12/504,609

(22) Filed: Jul. 16, 2009

Related U.S. Application Data
(63) Continuation of application No. 11/435,918, filed on May 17, 2006.
(60) Provisional application No. 61/164,226, filed on Mar. 27, 2009.

(51) Int. Cl. G06F 3/02

(52) U.S. Cl. 345/168

(57) ABSTRACT

Ergonomic computer control and/or input systems and components, such as, for example, keyboards and touchpad, and methods of using such computer control and/or input systems and components keyboard components that can be placed at varied or desired locations relative to the keyboard and devices that allow such keyboard components to be placed at the varied or desired locations.

This invention claims priority to U.S. Non-Provisional patent application Ser. No. 11/435,918 and U.S. Provisional Patent Applications 60/681,813, 60/710,745, 60/748,991, and 61/164,226, each of which is incorporated herein by references in its entirety.

### BACKGROUND

1. Field of the Invention

This invention is directed to ergonomic computer control and/or input components and methods of using such ergonomic computer control and/or input components.

2. Related Art

For many people, using a desktop or laptop computer is physically uncomfortable. Many people suffer back, neck, elbow, and/or wrist pain and/or injuries due to using a keyboard and mouse. Most computer keyboards force users to keep their hands, wrists, arms, shoulders, etc. locked in the same unnatural position, and force them to do the same repetitive motions, often causing the users fatigue and injury. Alternating between typing and using the mouse repeats the same repetitive motion over and over and can cause problems associated with repetitive stress injury.

The typical computer user positions a computer mouse approximately 15 inches from their typing hand position on the keyboard. A computer user will often unnecessarily find themselves having to move their hand 15 inches to and 15 inches back from, the mouse in order to use it to move the cursor on the screen only a fraction of an inch. Typical computer users also often find clicking the buttons of a mouse with their fingers over time can cause problems related to repetitive stress injury.

### SUMMARY OF THE DISCLOSED EMBODIMENTS

A very common problem related to the use of computers is stress and strain arising from the need of the typist to adopt a relatively stationary, often erect and rigid, posture when touch typing. Different types of keyboards and pointing devices have been designed to minimize these problems, but none of them address the fundamental issues relating to a person having to sit in one position doing repetitive movements for long periods of time. There is a need for a computer keyboard and mouse, or other control and/or input systems, components and methods, that allow a person to have more flexibility in how that person positions themselves relative to the computer and to have the ability to change positions and/or make alternative movements while using the computer.

In particular, instead of the person having to position their body to conform to a computer keyboard, the computer keyboard should conform to the human body, allowing the person to have several ways to control various functions and constantly make changes to their posture, arm, shoulder and wrist movements while they use the computer. Due to the repetitive nature of computer use, a person should have more than one way to control various computer functions. That is, improved computer control and/or input systems, components and methods that allow users to have greater control and flexibility in how the control and/or input elements are located relative to each other and to the users' body positions would be desirable. Such improved computer control and/or input systems, components and methods would reduce many problems associated with the more ergonomically limited systems and methods currently in use.

This invention provides movable ergonomic computer control and/or input systems and/or components.

This invention separately provides methods of using movable ergonomic computer control and/or input systems and/or components.

This invention separately provides movable ergonomic keyboard components.

This invention separately provides methods of using movable ergonomic keyboard components.

This invention separately provides movable ergonomic keyboard components having one or more additional non-keyboard functionalities.

This invention separately provides methods of using movable ergonomic keyboard components.

This invention separately provides movable ergonomic keyboard components having point-and-click capabilities.

This invention separately provides methods of using movable ergonomic keyboard components having point-and-click capabilities.

This invention separately provides movable ergonomic keyboard touchpads.

This invention separately provides methods of using movable ergonomic keyboard touchpads.

Instead of forcing the person to adapt their posture to the keyboard, in various exemplary embodiments according to this invention, movable ergonomic computer control and/or input systems, components and/or methods allow a person or user to adapt the keyboard to the user's individual posture and arm position. This allows the user to sit more comfortably and in many more positions. Various exemplary embodiments of movable ergonomic computer control and/or input systems, components and/or methods according to this invention allow the computer user to achieve an ergonomically correct typing position in many more environments than standard keyboards and mice. In various exemplary embodiments of movable ergonomic computer control and/or input systems, components and/or methods according to this invention, the keyboard and mouse are combined together, eliminating the need for the user to have to reach for the mouse. This tends to make it easier for the user to eliminate repetitive motion or other afflictions relating to using the keyboard and/or mouse.

In various exemplary embodiments, movable ergonomic computer control and/or input systems, components and/or methods according to this invention also allow the user to keep the desktop clear without the need for a special desk or computer tray. In various exemplary embodiments, movable ergonomic computer control and/or input systems, components and/or methods according to this invention provide redundancy of functions (e.g., mouse functions, scrolling, clicking, etc.). By providing the user with secondary devices with functions redundant to those provided by other elements of, for example, a keyboard, the user is able to use a diverse set of hand positions that can be altered over time. By giving the user a variety of potential hand positions, the user is able to reduce repetitive stress and the resulting injuries.

These and other features and advantages of various exemplary embodiments of systems, components and methods according to this invention are described in, or are apparent from, the following detailed descriptions of various exemplary embodiments of various devices, structures and/or methods according to this invention.

### BRIEF DESCRIPTION OF THE DRAWINGS

Various exemplary embodiments systems, components and/or methods according to this invention will be described in detail, with reference to the following figures, wherein:

FIG. 1 is a perspective view of a first exemplary embodiment of a computer control and/or input device according to this invention, including a first exemplary embodiment of a mounting device according to this invention;

FIG. 2 is a perspective view of the first exemplary embodiment of the computer control and/or input device shown in FIG. 1 mounted to a keyboard at a first desired location using the first exemplary embodiment of the mounting device;

FIG. 3 is a perspective view of the first exemplary embodiment of the computer control and/or input device shown in FIG. 1 showing the undersides of the first exemplary embodiment of the computer control and/or input device and the first exemplary embodiment of the mounting device shown in FIG. 1;

FIG. 4 is a perspective view of the first exemplary embodiment of the computer control and/or input device of FIG. 1 in use;

FIG. 5 is a perspective view of a second exemplary embodiment of a mounting device usable to mount the first exemplary embodiment of the computer control and/or input device shown in FIG. 1 to a keyboard;

FIG. 6 is a perspective view of the first exemplary embodiment of the computer control and/or input device shown in FIG. 1 mounted to a keyboard at a second desired location using the second exemplary embodiment of the mounting device shown in FIG. 5;

FIG. 7 is a perspective view of the first exemplary embodiments of the computer control and/or input and mounting devices shown in FIGS. 1 and 5 as they are placed at the second desired on the keyboard;

FIG. 8 is a perspective view of the first exemplary embodiments of the computer control and/or input and mounting devices shown in FIGS. 1 and 5 as they are placed at a third desired on the keyboard;

FIG. 9 is a perspective view of a third exemplary embodiment of a mounting device usable to mount the first exemplary embodiment of the computer control and/or input device shown in FIG. 1 to a keyboard;

FIGS. 10 and 11 are top and bottom perspective views of the first exemplary embodiment of the computer control and/or input device shown in FIG. 1 mounted to a keyboard at a fourth desired location using the third exemplary embodiment of the mounting device shown in FIG. 9;

FIG. 12 is a perspective view of a fourth exemplary embodiment of a mounting device usable to mount the first exemplary embodiment of the computer control and/or input device shown in FIG. 1 to a keyboard;

FIGS. 13 and 14 are top and bottom perspective views of the first exemplary embodiment of the computer control and/or input device shown in FIG. 1 mounted to a keyboard at a fifth desired location using the fourth exemplary embodiment of the mounting device shown in FIG. 12;

FIGS. 15 and 16 are top and bottom perspective views of a fifth exemplary embodiment of a mounting device usable to mount the first exemplary embodiment of the computer control and/or input device shown in FIG. 1 to a keyboard;

FIG. 17 is a perspective view of the first exemplary embodiment of the computer control and/or input device and the fifth exemplary embodiment of the mounting device shown in FIGS. 1, 15 and 16 as they are placed at a sixth desired on the keyboard;

FIG. 18 is a perspective view of a sixth exemplary embodiment of a mounting device usable to mount a second exemplary embodiment of the computer control and/or input device shown in FIG. 1 to a seventh desired location of the keyboard;

FIG. 19 is a perspective view of the sixth exemplary embodiment of the mounting device shown in FIG. 18 mounted at the seventh desired location of the keyboard;

FIG. 20 is a perspective view of the second exemplary embodiment of the computer control and/or input device and the sixth exemplary embodiment of the mounting device shown in FIGS. 18 and 19 in a raised configuration;

FIGS. 21 and 22 are perspectives view of a seventh exemplary embodiment of a mounting device usable to mount the first exemplary embodiment of the computer control and/or input device to a keyboard an eighth desired location on the keyboard;

FIG. 23 is a perspective view of the first exemplary embodiment of the computer control and/or input device and the seventh exemplary embodiment of the mounting device shown in FIGS. 1, 21 and 22 as they are placed at the eighth desired location on the keyboard;

FIG. 24 is a perspective view of a laptop computer having the first exemplary embodiments of the computer control and/or input and mounting devices shown in FIGS. 1 and 5 and a second exemplary embodiment of the computer control and/or input device according to this invention placed at desired locations on the laptop computer;

FIGS. 25 and 26 are perspective views of the first exemplary embodiment of the computer control and/or input device shown in FIG. 1 mounted to a first exemplary embodiment of a hand-held carrying device according to this invention; and

FIGS. 27 and 28 are perspective views of the first exemplary embodiment of the hand-held carrying device in different configurations.

### DETAILED DESCRIPTION OF THE DISCLOSED EMBODIMENTS

In various exemplary embodiments, components of the ergonomic computer control and/or input systems, components and/or methods according to this invention are repositionable on or about the keyboard or the like. Various exemplary embodiments of systems, components and methods according to this invention liberate the computer user from having to sit with their arms and body locked to a tabletop, desk or tray. In various exemplary embodiments, a mouse and/or other control and/or input device or component is combined with a keyboard using various exemplary embodiments of repositionable mounting devices according to this invention, making computer use physically more natural and relaxing, helping to eliminate fatigue and injuries related to both computer keyboard use and mouse use, offering people like police officers using computers in cars or others who type in ergonomically unfriendly environments a more comfortable, easy-to-use, and healthy option. This allows the user to use different attachment positions and/or to change the orientation and/or position of one or more of those components.

In various exemplary embodiments, a mouse, touch pad and/or other control and/or input device or component is combined according to this invention with the split computer keyboard disclosed in the incorporated co-pending U.S. Non-Provisional patent application Ser. No. 11/435,918 using various exemplary embodiments of repositionable ergonomic mounting devices according to this invention. The resulting combination can be used on a person's legs for better mobility and more posture options.

In various exemplary embodiments of the repositionable ergonomic computer control and/or input and mounting devices according to this invention, various ones of the hardware components are configured to increase, and ideally maximize, the user's ability to change typing positions or styles over time. This should reduce, and ideally minimize, repetitive stress injuries, soreness, etc. In various exemplary embodiments, multiple components of the repositionable ergonomic computer control and/or input systems, components and/or methods according to this invention are provided with redundant features to allow the user to switch from one component to another over time to permit a change in hand, wrist, arm, or other body positions.

Additionally, in various exemplary embodiments of the repositionable ergonomic computer control and/or input systems, components and/or methods according to this invention, various components may be separable to allow different attachment positions and/or the addition of different components to change the shape and position of the devices. Software may also be employed to change the function of particular buttons or other components over time. That is, in various exemplary embodiments, the functions of one or more buttons or other active structures on the one or more components may be changed or remapped based on elapsed time, active application, etc.

In various exemplary embodiments, the user may have control over the individual elements, properties, and/or options of the movable ergonomic computer control and/or input systems, components and/or methods according to this invention. For example, the user may have the option to set the velocity of the pointing arrow to one speed when using a mouse component and to a different speed when using a touchpad component. This allows the user to have both “quick” and “slow” cursor movement functions available to the user at all time, rather than having to actively access an options or control screen to semi-permanently change the velocity.

For example, in some exemplary embodiments, the mouse component is configured to be in line with the user's hand and arm, so that the user's hand can grip the mouse in an ergonomic manner without the user needing to twist or bend their wrist when using the mouse. In some exemplary embodiments, a mouse or a motion-sensing LED is located, for example, under the keyboard. The repositionable ergonomic computer control and/or input systems, components and/or methods according to this invention, when in this configuration, allow the computer user to achieve an ergonomically correct typing position in many more environments. The repositionable ergonomic computer control and/or input systems, components and/or methods according to this invention also do not rely upon special chairs, trays or desks. This allows the user to sit naturally and to change posture with great ease and flexibility, while continuing to type and use the mouse, touchpad and/or other control and/or input device. This also allows the user to sit in positions recognized for their ergonomic benefits, as well as positions associated with relaxation, without having to adjust a computer tray or a chair.

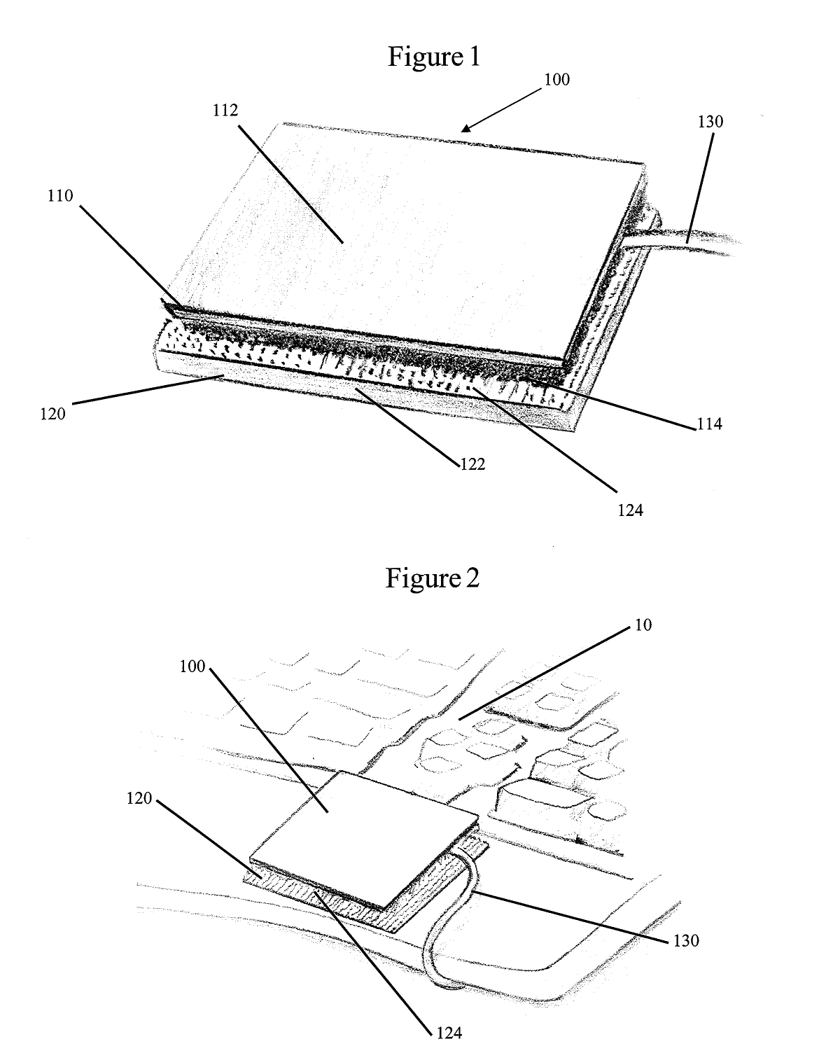

FIGS. 1-4 illustrate a first exemplary embodiment of a repositionable ergonomic computer control and/or input device 100 according to this invention. As shown in FIGS. 1-4, the repositionable ergonomic computer control and/or input device 100 includes a first control/input device, which in this exemplary embodiment is a touchpad 110, and first exemplary embodiment of a mounting device 120 according to this invention. As shown in FIGS. 1, 3 and 4, the touchpad 110 includes a top, active surface 112 usable by the user to control a cursor of, input control signals to, and the like for a desktop, laptop or other computing device that the touchpad 110 can be connected to using the signal/power cable 130. The touchpad 110 also includes a connector 114 that is attached or mounted to a back side of the touchpad 110.

As shown in FIGS. 1-4, the first mounting device 120 includes an attaching structure 122 usable to repositionably position the first mounting device 120 at any desired location such that the repositionable ergonomic computer control and/or input device 100 according to this invention does not readily move from the desired location as it is used by the computer user to interact with the computer. The first mounting device 120 also includes a connector 124 that connects to the connector 114 attached or mounted to the back side of the touchpad 110. It should be appreciated that, in this first exemplary embodiment, the attaching structure 122 is usable to at least temporarily position the first mounting device 120 to a keyboard 10, a keyboard surface of a laptop or other portable computing device, a desktop or other surface that the keyboard 10 is on and/or is adjacent to, or any other surface a user finds appropriate and/or desirable when that user is interacting with the computer.

As shown in FIG. 1, in a first exemplary embodiment of the “attaching” structure 122, the “attaching” structure 122 is a pad or other layer of material and has a sufficiently high surface roughness and/or surface energy, such as the foam material commonly used for mousepads, so that the pad 122 will not readily move relative to the surface on which it has been placed. Thus, it should be appreciated that the attaching structures according to this invention do not have to mechanically attach, fasten, join, fix or otherwise secure the first mounting device 120 to the desired surface, so long as the repositionable ergonomic computer control and/or input device 100 according to this invention does not readily move from the desired location as it is used.

One surface of the pad 122 faces the keyboard 10, desktop, and/or other appropriate surface (as outlined above), while the other surface of the foam pad 122 is attached to the connector 124. The material used to form the pad 122, due to having a sufficiently high surface roughness and/or surface energy, tends to “grab” the surface it is placed on. Thus, when placed on the desired surface, such as a desktop, the surface of the keyboard 10 and/or other appropriate surface, the pad 122, and thus the repositionable ergonomic computer control and/or input device 100, does not readily move relative to that surface. In various exemplary embodiments, the pad 122 is a foam material, which is typically resilient and/or compressible. This can add comfort to the repositionable ergonomic computer control and/or input device 100.

FIG. 2 shows the first mounting device 120 with a second exemplary embodiment of the attaching structure 122. As shown in FIG. 2, in place of the pad 122 used in the first exemplary embodiment, the attaching structure 122 is a layer of adhesive placed on a back surface of the connector 124. The adhesive is at least strong enough, such that, when the first mounting device 120 is placed on a surface of the keyboard 10, first mounting device 120 does not readily move relative to that surface of the keyboard 10. In different embodiments, the adhesive layer 122 can have different physical properties and/or strengths. For example, in some exemplary embodiments, the adhesive layer 122 can permanently secure the first mounting device 120 to the keyboard 10 or other desired surface or location. In other exemplary embodiments, the adhesive layer 122 can detachably attach the first mounting device 120 to the keyboard 10, so that the mounting device 120 can be detached from the keyboard 10 and moved to another location, such as another location on the keyboard 10. Furthermore, even if detachable, different strength adhesives can be used depending on the desired amount of force to be required to detach the first mounting device 120 from the keyboard 10.

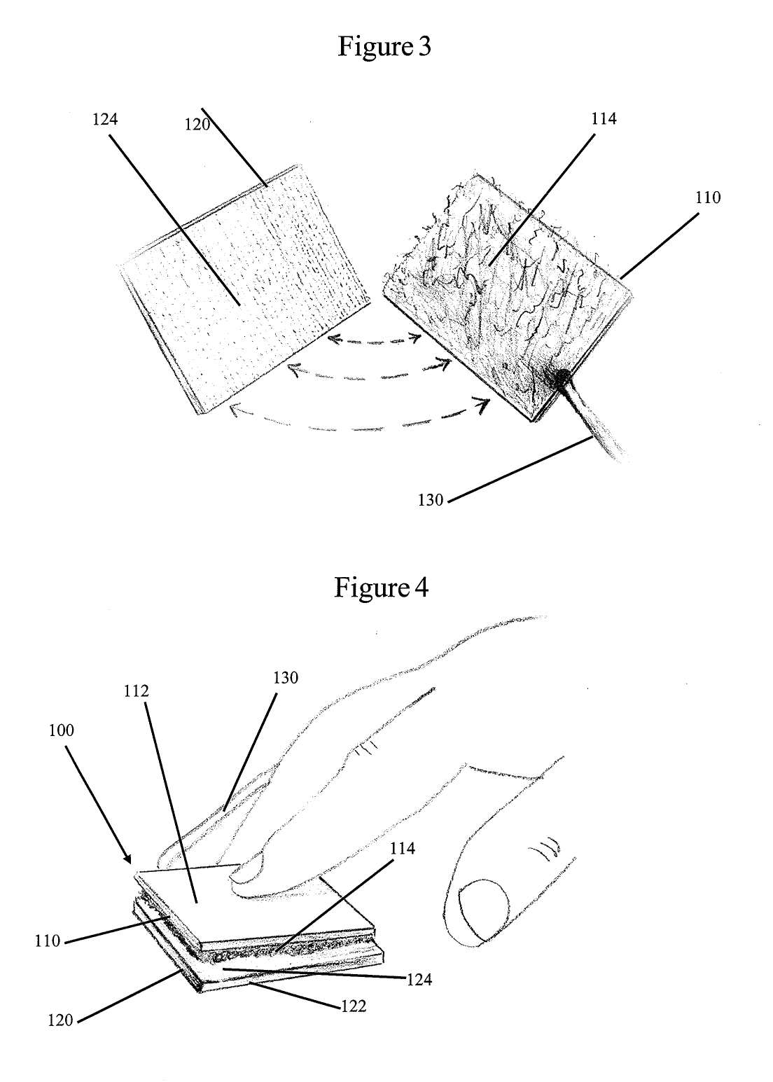

As indicated above, the touchpad 110 and the first mounting device 120 include the connectors 114 and 124. In various exemplary embodiments, the connectors 114 and 124 can be readily and repeatedly connected and disconnected without damaging them or otherwise decreasing their ability to securely connect to each other. As most easily seen in FIG. 3, the connectors 114 and 124 are typically complementary components of a two-part fastening structure or mechanism. That is, the connector 114 is typically a first part of the two-part fastening structure, such as the loop portion of a hook-&-loop fastener (i.e., Velcro®), while the connector 124 is a second, complementary part of the two-part fastening structure, such as the hook portion of the hook-&-loop fastener. It should be appreciated that either portion of any known or later-developed two-part fastening structure can be used as the connector 114, so long as the complementary part of the two-part fastening structure is used as the connector 124.

As shown in FIG. 3 after the attaching structure 122 of the first mounting device 120 is secured to a desired location on the keyboard 10, the connectors 114 and 124, as complementary parts of a two-part connector, can be brought together to attach the touchpad 110 to the keyboard 10. This desired location, such as that shown in FIG. 2, will depend on the user, and will typically be selected to reduce stress and strain on the user's hands, fingers and/or wrists as the user interacts with the computing device the touchpad 110 is connected to. The user can then, as shown in FIG. 4, readily use the touchpad 110 in its desired location.

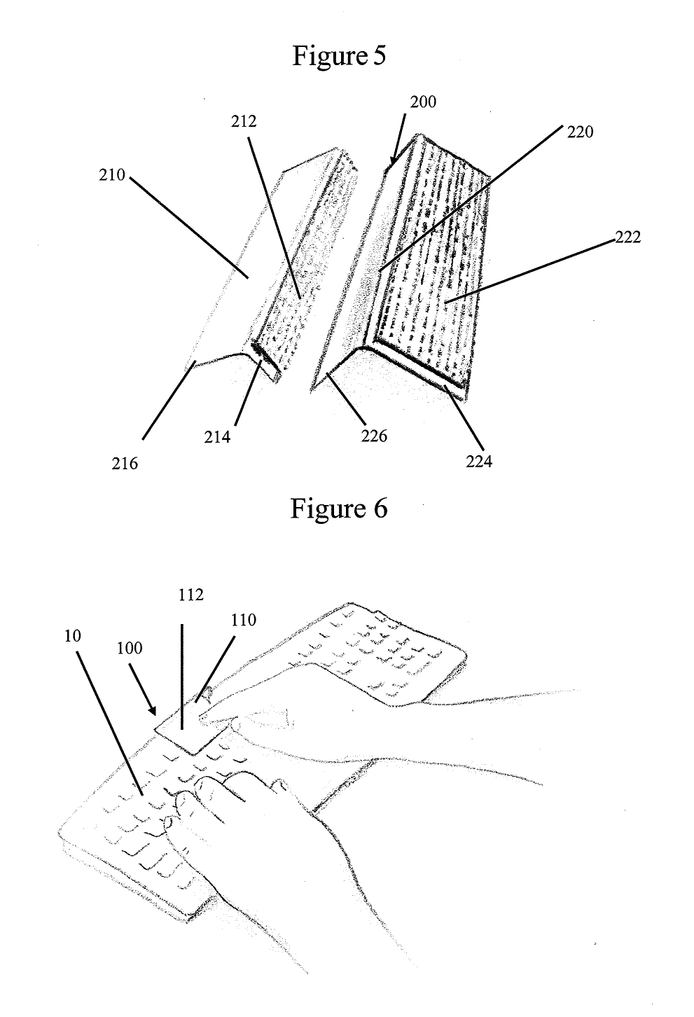

FIG. 5 is a perspective view of a second exemplary embodiment of a mounting device 200 usable as part of the first exemplary embodiment of the repositionable ergonomic computer control and/or input device 100 to mount the touchpad 110, or other control/input device, shown in FIG. 1 to the keyboard 10. FIG. 6 is a perspective view of the first exemplary embodiment of the computer control and/or input device 100 mounted to the keyboard 10 at a second desired location using the mounting device 200. In particular, the mounting device 200 includes first and second keyboard clip members 210 and 220, respectively. As shown in FIG. 5, the first keyboard clip member 210 includes first and second legs 214 and 216 and a portion 212 of the second connector 124 provided on its first leg 214. Similarly, the second keyboard clip member 220 includes first and second legs 224 and 226 and a portion 222, or another instance, of the second connector 124 provided on its first leg 224.

In various exemplary embodiments, the first and second keyboard clip members 210 and 220 are each formed of a single piece of a generally rigid yet plastically deformable material, such as aluminum or steel sheet metal, plastic or the like. In the exemplary embodiment shown in FIG. 5, the first and second legs 214 and 216, and 224 and 226, of the first and second keyboard clip members 210 and 220, respectively, typically meet to form a right angle. However, it should be appreciated that the first and second legs 214 and 216, and 224 and 226, of the first and second keyboard clip members 210 and 220 can form any desired angle useable to allow the first and second keyboard clip members 210 and 220 to engage one or more rows of keys on the keyboard 10.

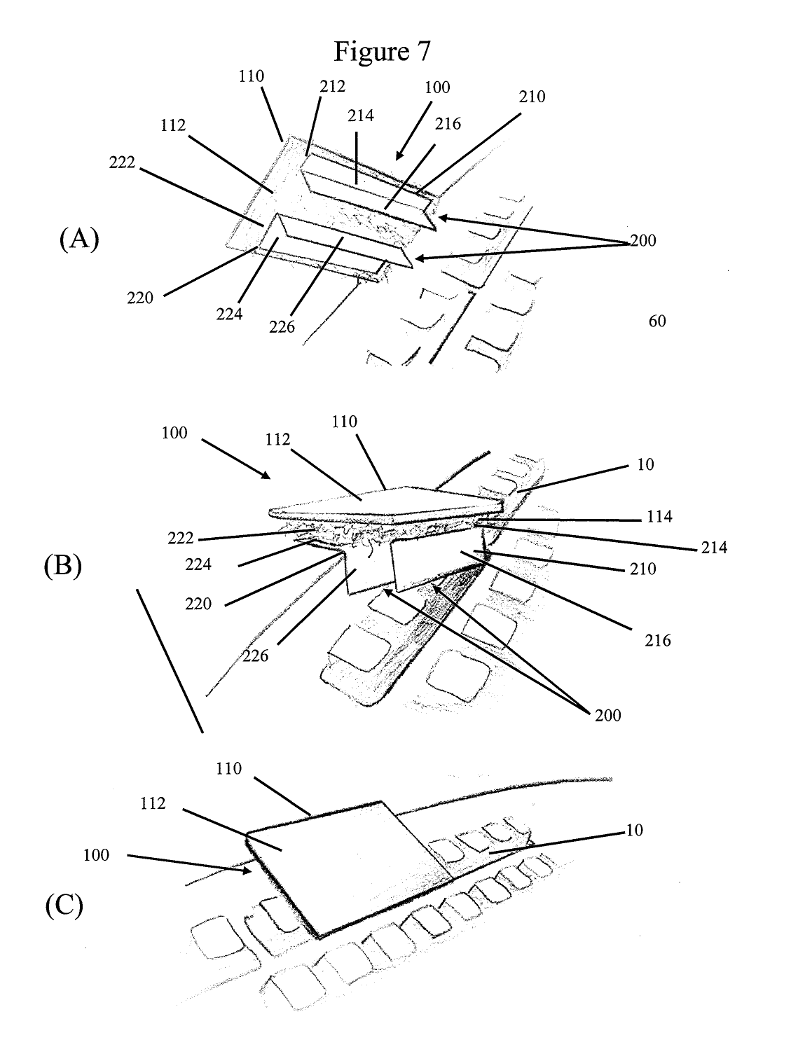

FIG. 7 is a perspective view showing first and second keyboard clip members 210 and 220 connected to the connector 114 of the touchpad 110 as the repositionable ergonomic computer control and/or input device 100 is placed at the second desired location on the keyboard. As shown in part A of FIG. 7, the first and second keyboard clip members 210 and 220, when connected to the connector 114 of the touchpad 110, are oriented so that the first legs 214 and 224 extend away from each other and the second legs 216 and 226 are adjacent to each other. Additionally the second legs 216 and 226 are spaced from each other by about the width of a single row of keys of the keyboard 10.

It should be appreciated that, in this exemplary embodiment, the first legs 214 and 224 used to support the portions or components 212 and 222 of the second connector have 2 different sizes. In particular, having one relatively thinner first leg 214 allows that keyboard clip member 210 to be positioned close to the edge of the touchpad 110 so the repositionable ergonomic computer control and/or input device 100 can be put in very tight spots on the keyboard 10 without interfering with the operation of adjacent keyboard keys. In contrast, having one relatively fatter first leg 224 provides that keyboard clip member 220 with a portion or component 222 having more surface area, which creates greater connection force between that portion or component 222 of the second connector 124 and the first connector 114 the touchpad 110. This results in the touchpad or other control/input device 110 being held more securely to the second keyboard clip member.

As shown in part B of FIG. 7, the first and second keyboard clip members 210 and 220 are placed adjacent to a single row of keys of the keyboard 10 at the desired location on the keyboard 10. The first and second keyboard clip members 210 and 220 are then lowered so that their second legs 216 and 226 bracket that single row of keys of the keyboard 10. Finally, as shown in part C of FIG. 7, the second legs 216 and 226 of the first and second keyboard clip members 210 and 220 extend down around that single row of keys and into the spaces between that single row of keys and one or more adjacent rows of keys and/or the upper frame of the keyboard 10 to securely locate the repositionable ergonomic computer control and/or input device 100 at the second desired location.

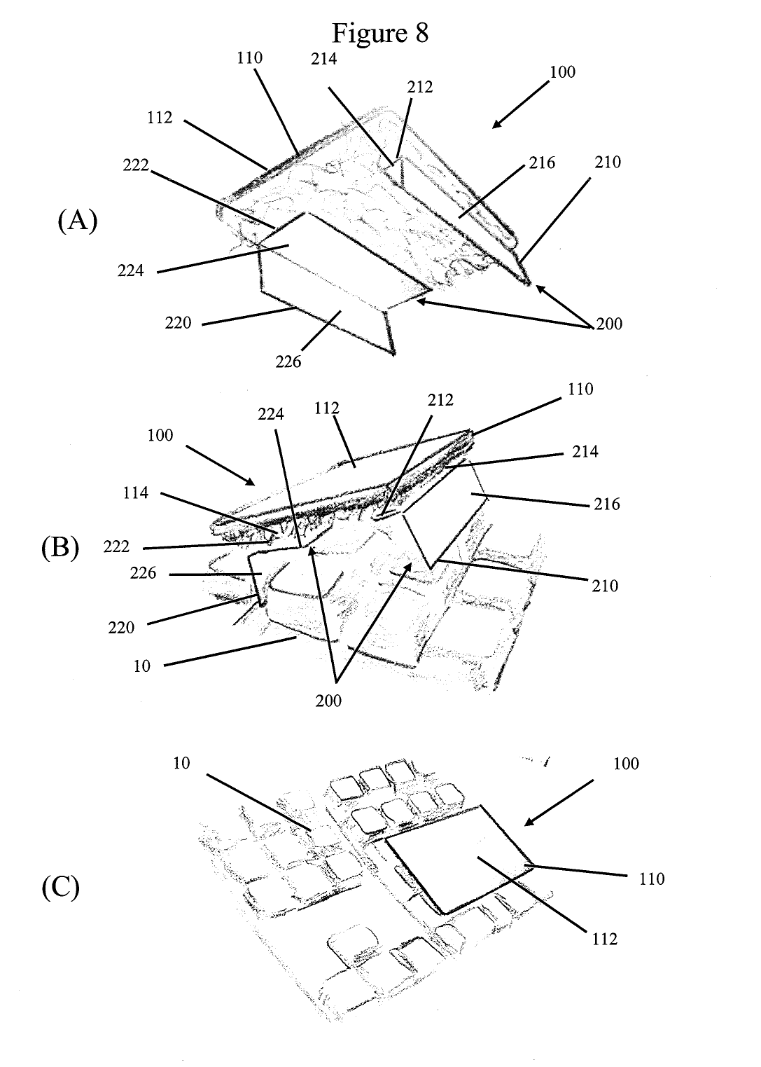

FIG. 8 is a perspective view showing first and second keyboard clip members 210 and 220 connected to the connector 114 of the touchpad 110 as the repositionable ergonomic computer control and/or input device 100 is placed at a third desired location on the keyboard. As shown in part A of FIG. 8, the first and second keyboard clip members 210 and 220, when connected to the connector 114 of the touchpad 110, are oriented so that the first legs 214 and 224 extend toward each other and the second legs 216 and 226 are spaced away from each other. In contrast to the orientation shown in FIG. 7, in FIG. 8, the second legs 216 and 226 are spaced from each other by about the width of two rows of keys of the keyboard 10.

As shown in part B of FIG. 8, the first and second keyboard clip members 210 and 220 are placed adjacent to a pair of rows of keys of the keyboard 10 at the desired third location on the keyboard 10. The first and second keyboard clip members 210 and 220 are then lowered so that their second legs 216 and 226 bracket that pair of rows of keys of the keyboard 10. Finally, as shown in part C of FIG. 8, the second legs 216 and 226 of the first and second keyboard clip members 210 and 220 extend down around that pair of rows of keys and into the spaces between each one of that pair of rows and either an adjacent row of keys or the upper frame of the keyboard 10. Thus, as with the orientation shown in FIG. 7, the second legs 216 and 226 of the first and second keyboard clip members 210 and 220 securely locate the repositionable ergonomic computer control and/or input device 100 at the third desired location.

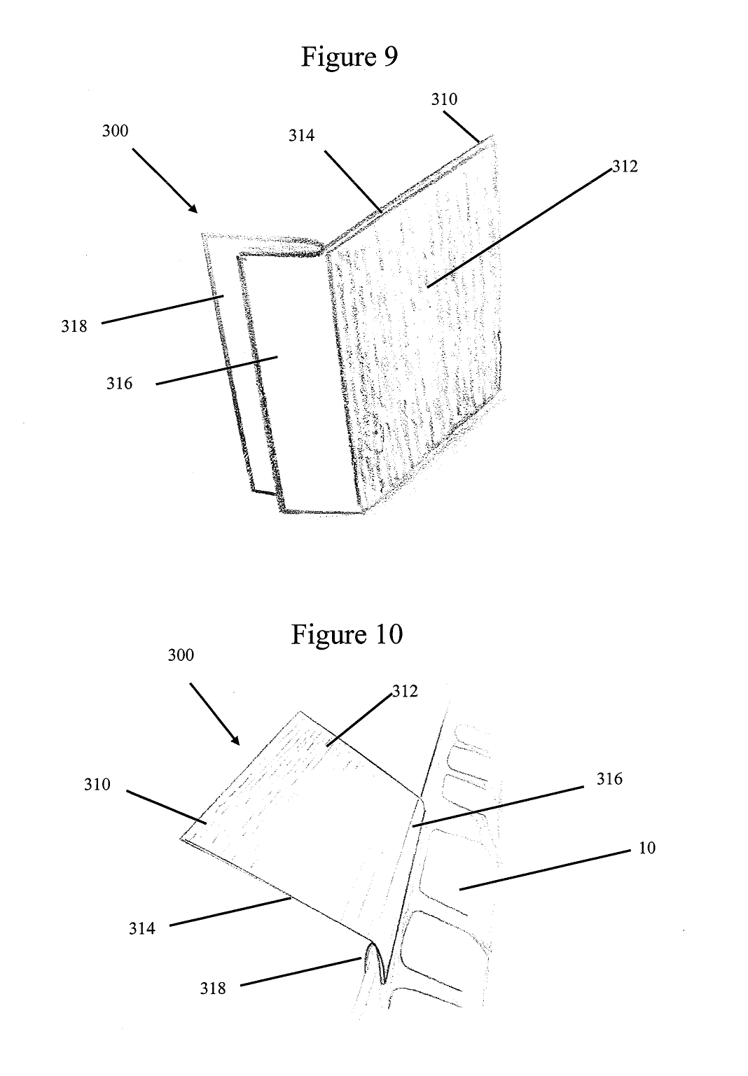

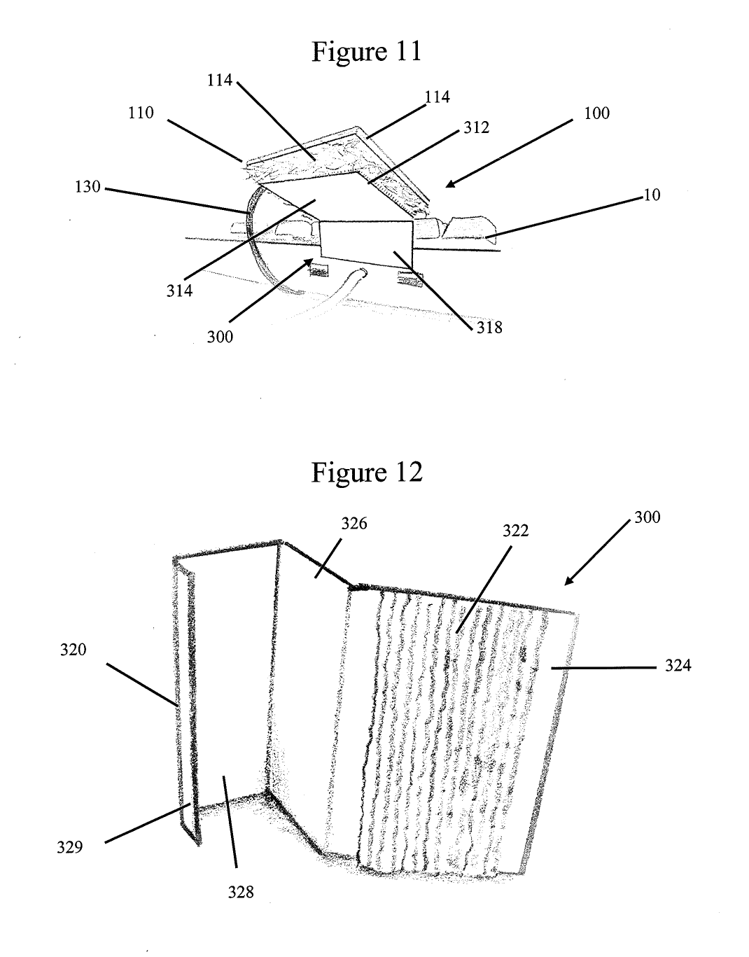

FIGS. 9-14 illustrate third and fourth exemplary embodiments of a mounting device 300 according to this invention. These exemplary mounting devices 300 are particularly useful for specific types of keyboards, such as those commonly used with Apple-brand computers. In particular, the third exemplary embodiment of the mounting device 300 shown in FIGS. 9-11 is useful when they keyboard 10 has a ridge or rib element or the like, while the fourth exemplary embodiment of the mounting device 300 shown in FIGS. 12-14 is useful when they keyboard 10 has an extended rectangular foot or the like, used to tilt the keyboard 10 by raising its back end, located at the back bottom edge of the keyboard 10.

As shown in FIG. 9, in this third exemplary embodiment, the mounting device 300 includes a body 310 and a portion 312, or another instance, of the second connector 124. The body 310 includes first, second and third legs 314, 316 and 318. The portion 312, or another instance, of the second connector 124 is attached to the first leg 314. In various exemplary embodiments, the body 310 is a generally rigid yet plastically deformable material, such as aluminum, steel, plastic or the like.

In the exemplary embodiment shown in FIG. 9, the first, second and third legs 314-318, typically meet at (or near) a single point on the body 310. The second and third legs 316 and 318 are adjacent to each other, and more or less parallel, while the first leg 314 extends away from the second and third legs 316 and 318. The second and third legs 316 and 318 are placed on either side of the keyboard ridge or rib element at the fourth desired location to securely grasp or pinch that ridge or rib element between them. It should be appreciated that the second and third legs 316 and 318 can be spaced from each other by any appropriate distance and/or form any desired angle between them that is useable to engage the ridge or rib element of the keyboard 10.

FIGS. 10 and 11 are top and bottom perspective views of the first exemplary embodiment of the computer control and/or input device 100 shown in FIG. 1 mounted to a keyboard at the fourth desired location using the third exemplary embodiment of the mounting device 300 shown in FIG. 9. As shown in FIGS. 10 and 11, when the body 310 is mounted onto the ridge or rib element of the keyboard 10, the first leg 314 extends upwardly and away from the keyboard 10. As a result, when the connector 114 of the touchpad 110 is connected to the portion 312, or another instance, of the connector 124 that is attached to the first leg 314, the touchpad 110 is held at the fourth desired location on the keyboard 10 in a generally ergonomically comfortable position. It should be appreciated that the first leg 314 will typically extend away from the second and third legs 316 and 318 at an angle that places the touchpad 110 so that it is generally parallel to the surface of the keyboard keys. However, it should be appreciated that body 310 can be bent or the like so that the first leg 314 extends away from the second and third legs 316 and 318 at any angle the user finds comfortable or desirable.

As shown in FIG. 12, in this fourth exemplary embodiment, the mounting device 300 includes a body 320 and a portion 322, or another instance, of the second connector 124. The body 320 includes first, second, third and fourth legs 324, 326, 328 and 329. The portion 322, or another instance, of the second connector 124 is attached to the first leg 324. In various exemplary embodiments, the body 320 is a generally rigid yet plastically deformable material, such as aluminum or steel sheet metal or the like, plastic or the like.

In the exemplary embodiment shown in FIG. 12, the first, second, third and fourth legs 324, 326, 328 and 329 forming the body 320 are joined end to end and are oriented to each other so the second, third and fourth legs 326, 328 and 329 of the body 310 wrap around the rectangular foot of the keyboard 10. Typically, but depending on the specific shape of the foot, the second and third legs 326 and 328 and the third and fourth legs 328 and 329 are at right angles to each other, while the first leg 324 extends away from the second legs 326.

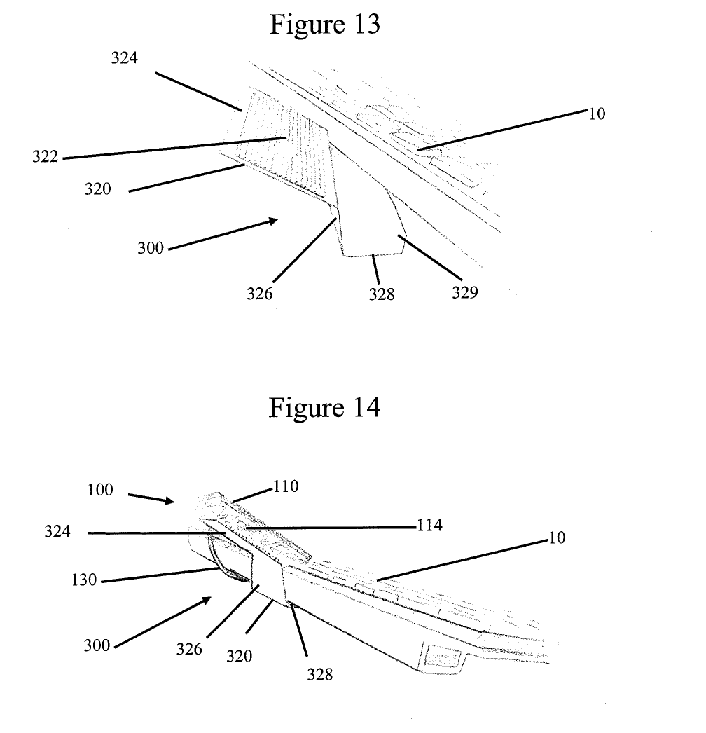

FIGS. 13 and 14 are top and bottom perspective views of the first exemplary embodiment of the computer control and/or input device 100 shown in FIG. 1 mounted to a keyboard at the fourth desired location using the fourth exemplary embodiment of the mounting device 300 shown in FIG. 12. As shown in FIGS. 13 and 14, when the foot of the keyboard 10 is placed onto the body 320, the first leg 324 extends upwardly and away from the keyboard 10. In particular, the foot of the keyboard 10 is placed on to the body 310 such that the second-fourth legs 326-329 wrap around the foot at the fourth desired location to securely hold the first leg 324 at a desired orientation relative to the keyboard 10. It should be appreciated that the second-fourth legs 326-329 can have any desired or appropriate length and/or angle between adjacent ones of the second-fourth legs 326-329 that are useable to securely engage the foot of the keyboard 10.

Thus, when the connector 114 of the touchpad 110 is connected to the portion 322, or another instance, of the connector 124 that is attached to the leg 324, the touchpad 110 is held at the fourth desired location on the keyboard 10 in a generally ergonomically comfortable position. It should be appreciated that the first leg 324 will typically extend away from the second leg 326 at an angle that places the touchpad 110 so that it is generally parallel to the surface of the keyboard keys. However, it should be appreciated that body 320 can be bent or the like so that the first leg 324 extends away from the second leg 326 at any angle the user finds comfortable or desirable.

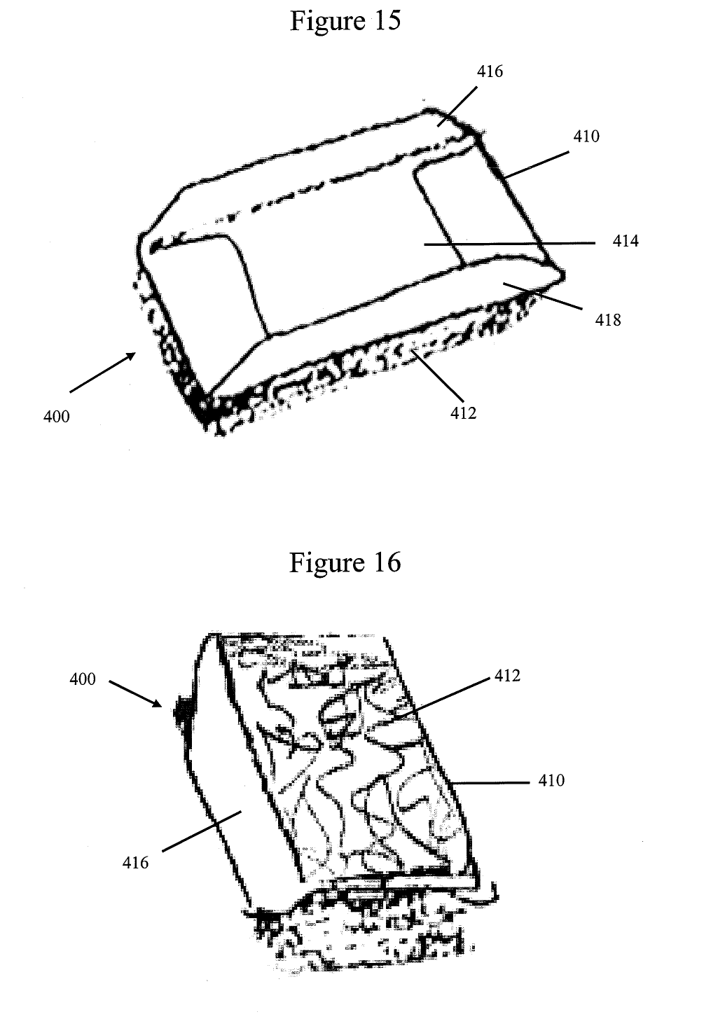

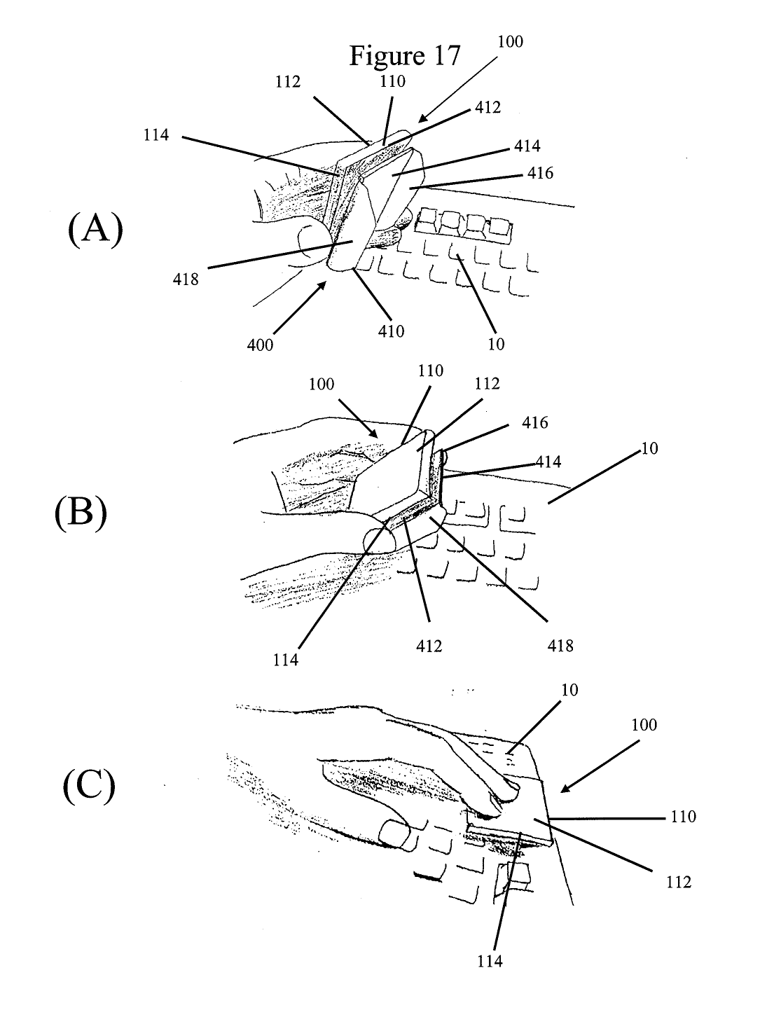

FIGS. 15 and 16 are top and bottom perspective views of a fifth exemplary embodiment of a mounting device 400 usable to mount the first exemplary embodiment of the computer control and/or input device 100 shown in FIG. 1 to a keyboard at a sixth desired location. FIG. 17 is a perspective view of the first exemplary embodiment of the computer control and/or input device 100 and the fifth exemplary embodiment of the mounting device 400 as they are placed at the sixth desired location on the keyboard.

As shown in FIGS. 15 and 16, the fifth exemplary embodiment of a mounting device 400 includes a body 410 and a portion 412, or another instance, of the second connector 124. The body 410 includes first, second and third legs 414, 416 and 418. The portion 412, or another instance, of the second connector 124 is attached to the first leg 414. The second and third legs 416 and 418 extend from opposite edges of the first leg 414, and are generally form right angles with the first leg 414. In various exemplary embodiments, the body 410 is a generally rigid yet plastically deformable material, such as aluminum or steel sheet metal or the like, plastic or the like.

As shown in part A of FIG. 17, the connector 114 of the touchpad 110 is attached to the portion 412, or another instance, of the second connector 124 to secure the touchpad 110 to the body 410. The second and third legs 416 and 418 extend away from the first leg 414 toward the keyboard 10, and if desired, can be adjusted so that they extend toward each other. The second and third legs 416 and 418 are also spaced away from each other by about the width of two rows of keys of the keyboard 10.

As shown in part B of FIG. 17, the second and third legs 416 and 418 of the body 410 are placed adjacent to one or more rows of keys of the keyboard 10 at the desired sixth location on the keyboard 10. The body 410 is then lowered so that the second and third legs 416 and 418 bracket those one or more rows of keys of the keyboard 10. Finally, as shown in part C of FIG. 17, the second and third legs 416 and 418 of the mounting device 400 extend down around those one or more rows of keys and into the spaces between the outside ones of those one or more rows and either an adjacent row of keys or the upper frame of the keyboard 10. Thus, as with the embodiment shown in FIG. 8, the second and third legs 416 and 418 of the body 410 securely locate the repositionable ergonomic computer control and/or input device 100 at the third desired location.

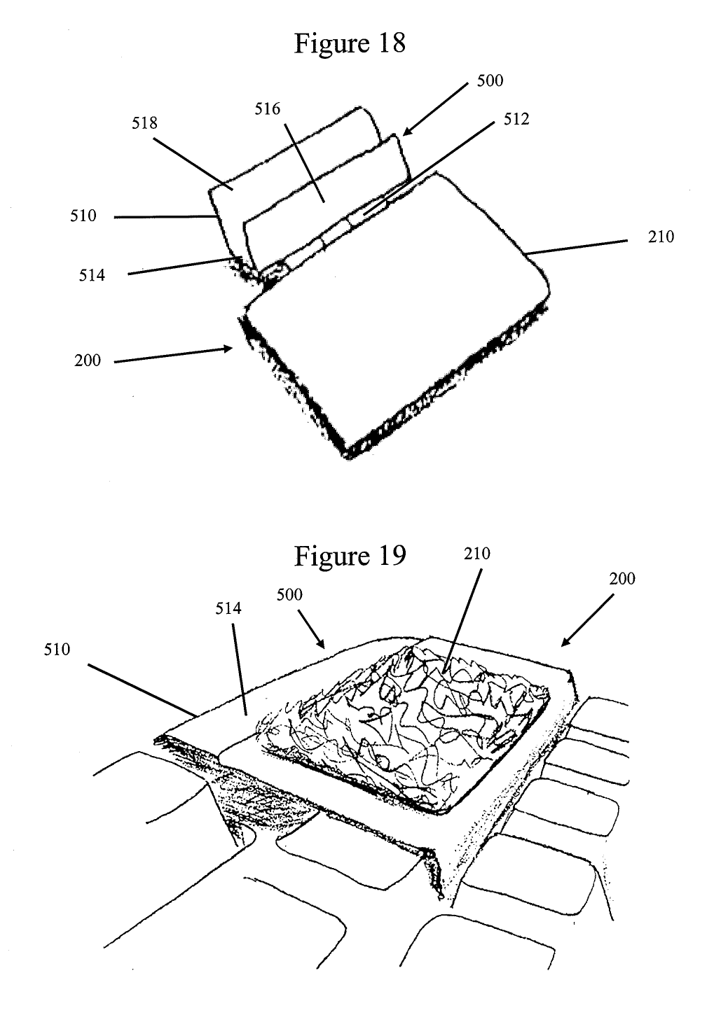

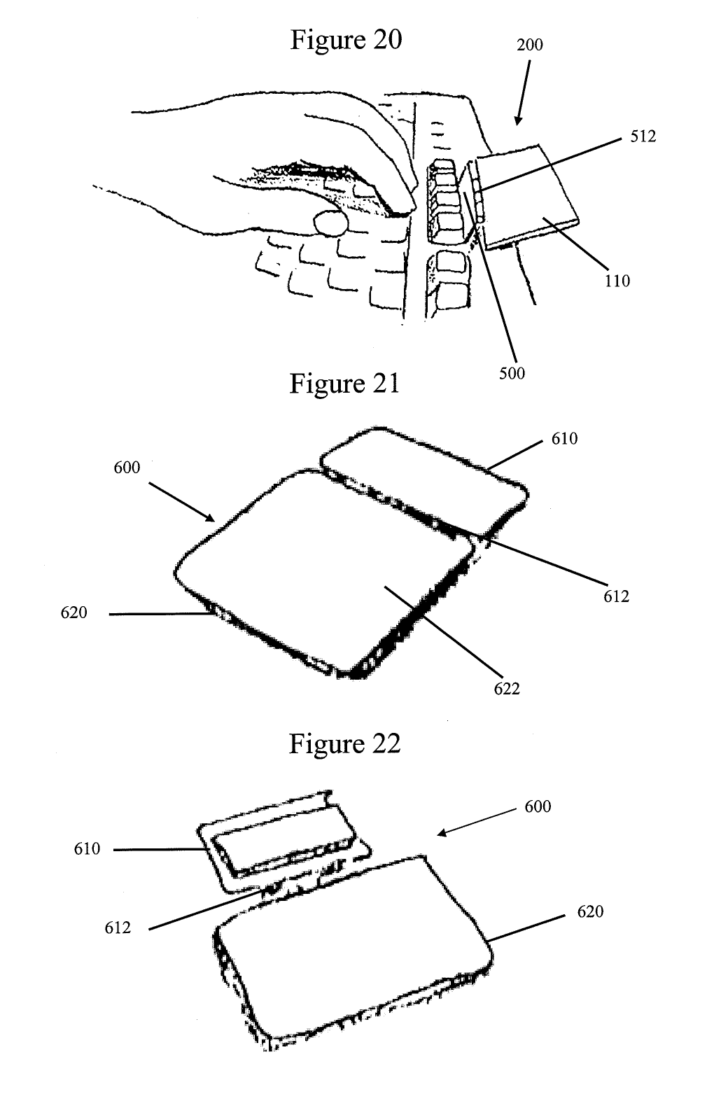

FIG. 18 is a perspective view of a sixth exemplary embodiment of a mounting device 500 usable to mount a second exemplary embodiment of the computer control and/or input device 200 shown in FIG. 1 to a seventh desired location of the keyboard. FIG. 19 is a perspective view of the sixth exemplary embodiment of the mounting device 500 shown in FIG. 18 mounted at the seventh desired location of the keyboard. FIG. 20 is a perspective view of the second exemplary embodiment of the computer control and/or input device 200 and the sixth exemplary embodiment of the mounting device 500 shown in FIGS. 18 and 19 in a raised configuration.

In particular, as shown in FIGS. 18-20, in this sixth exemplary embodiment, the mounting device 500 includes a body 510 that is directly connected to the touchpad 210 by a hinge 512. As shown in FIG. 18, in a first exemplary embodiment of the body 510, the body 510 includes first, second and third legs 514, 516 and 518. The second and third legs 516 and 518 extend from opposite edges of the first leg 514, and are generally form right angles with the first leg 514. In this first exemplary embodiment, the hinge 512 is attached to the body 510 where the first and second legs 514 and 516 meet. In various exemplary embodiments, the body 510 is a generally rigid yet plastically deformable material, such as aluminum or steel sheet metal or the like, plastic or the like. The body 510 can be placed over one or more rows of keys of the keyboard, depending on the length of the first leg 514, in a manner similar to that described above relative to the body 410.

As shown in FIG. 20, in a second exemplary embodiment of the body 510, the body 510 includes a first leg 514. In this second exemplary embodiment, the hinge 512 is attached to the body 510 at one end of the first leg 514. In various exemplary embodiments, the body 510 is a generally rigid material, such as aluminum or steel sheet metal or the like, plastic or the like. The body 510 can be adjacent to a row of keys of the keyboard, by inserting the first leg 514 into a gap or space between that row of keys and an adjacent row of keys or an adjacent frame of the keyboard.

As shown in FIG. 19, when the user wishes to use the touchpad 210, the user rotates the touchpad 210 clockwise around the hinge 512 so that it extends over or lies on one or more rows of keys of the keyboard 10. In contrast, as shown in FIG. 20, when the user wishes to access one or more of the keys that the touchpad 210 extends over, the user merely rotates the touchpad 210 counter-clockwise around the hinge 512 to expose those keys. Thus, in such exemplary embodiments, the user can reposition the touchpad or other control/input device 210 without having to physically remove the repositionable ergonomic computer control and/or input device 200 from its desired location on the keyboard 10.

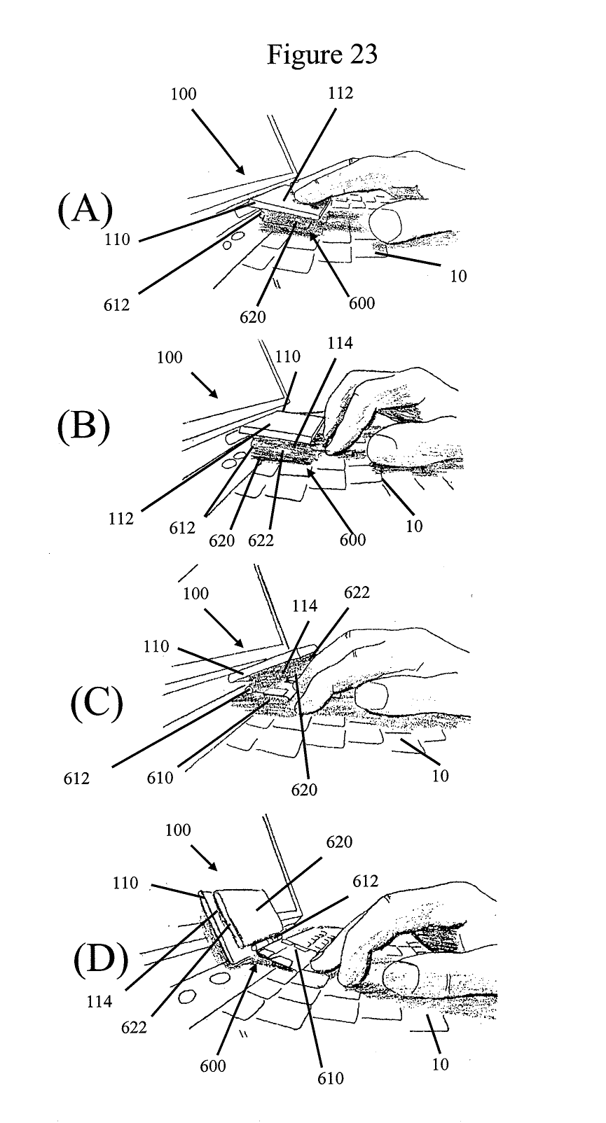

FIGS. 21 and 22 are perspectives view of a seventh exemplary embodiment of a mounting device 600 usable to mount the first exemplary embodiment of the computer control and/or input device 100 to a keyboard at an eighth desired location on the keyboard. FIG. 23 is a perspective view of the first exemplary embodiment of the computer control and/or input device 100 and the seventh exemplary embodiment of the mounting device 600 shown in FIGS. 21 and 22 as they are placed at the eighth desired location on the keyboard.

As shown in FIGS. 21 and 22, in this seventh exemplary embodiment, the mounting device 600 includes a first body 610 and a second body 620 that are connected together by a hinge 612. In this exemplary embodiment, the second body 620 includes a portion 622, or another instance, of the second connector 124. It should be appreciated that, while the second body 620 is generally flat or planar, the first body 610 can be implemented by any appropriate one of the previously described embodiments shown in FIGS. 1-20. Thus, the body 610 can be placed over one or more rows of keys of the keyboard in a manner similar to that described above. It should also be appreciated that, in various exemplary embodiments, the bodies 610 and 620 are each formed of a generally rigid yet plastically deformable material, such as aluminum or steel sheet metal or the like, plastic or the like. Finally, it should further be appreciated that the connector 114 of the touchpad 110 is attached to the portion 622, or another instance, of the second connector 124 to secure the touchpad 110 to the body 620.

As shown in part A of FIG. 23, in this sixth exemplary embodiment, when the user wishes to use the touchpad 110, the user rotates the touchpad 110, and thus the body 620, clockwise around the hinge 612 so that the touchpad 110 and the body 620 extend over or lie on one or more rows of keys of the keyboard 10. The user can then interact with the active surface 112 of the touchpad 110.

As shown in parts B and C of FIG. 23, when the user wishes to access one or more of the keys that the touchpad 110 and the body 620 extend over, the user merely extends one or more fingers under the touchpad 110 and then the body 620 to begin rotating the touchpad 110 and the body 620 counter-clockwise around the hinge 612. The user then merely needs to push up, for example by flicking the user's fingers, against the bottom surfaces of the touchpad 110 and/or the body 610 to place the touchpad 110 and the body 620 into the fully raised position shown in part D of FIG. 23 and to expose those keys. Thus, in such exemplary embodiments, the user can reposition the touchpad or other control/input device 110 without having to physically remove the repositionable ergonomic computer control and/or input device 100 from its desired location on the keyboard 10.

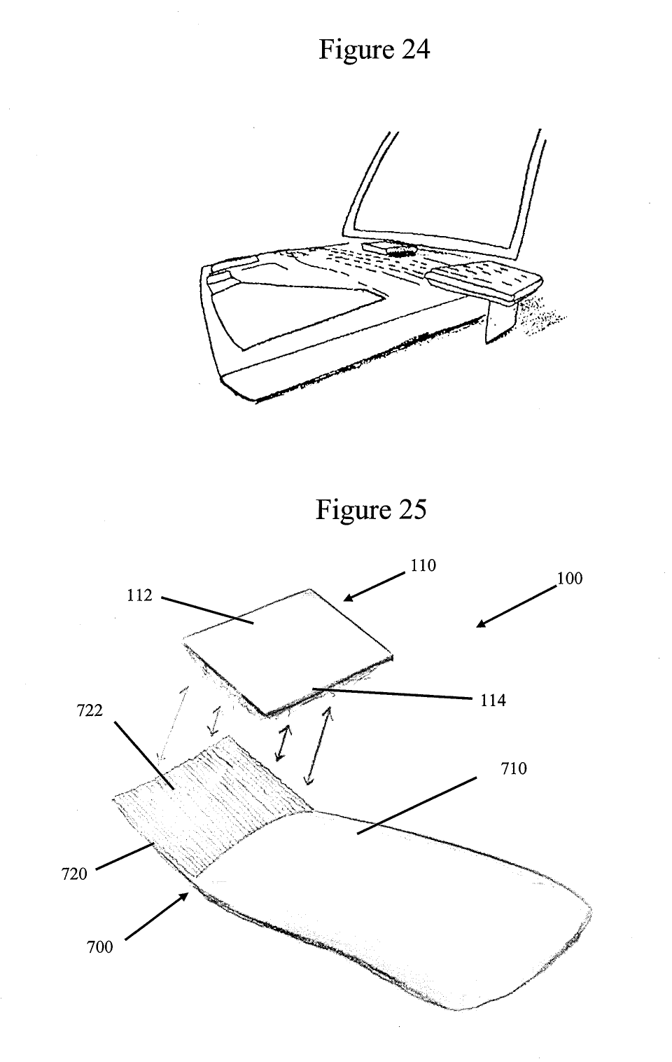

FIG. 24 is a perspective view of a laptop computer having the first exemplary embodiments of the touchpad and/or control/input device 110 shown in FIG. 1, and a second exemplary embodiment of a control/input device 150 according to this invention, where each is placed at a desired location on the laptop computer. In various exemplary embodiments, this second control/input device 150 can be an auxiliary or secondary keypad, such as a numeric keypad, or any other known or later-developed control and/or input device. Moreover, each of the touchpad 100 and second control/input device 150 can be repositionably mounted to the keyboard 10 using any one of the above-described exemplary mounting devices shown in FIGS. 1-23.

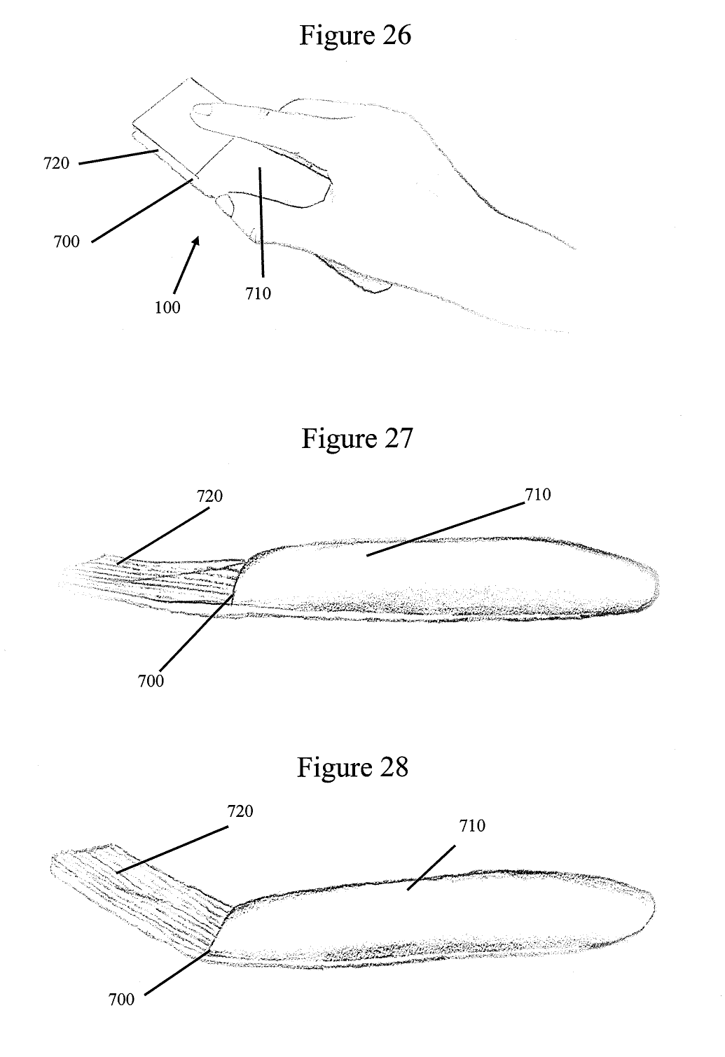

FIGS. 25-28 show the first exemplary embodiment of the touchpad or other control/input device 110 shown in FIG. 1 mounted to a first exemplary embodiment of a hand-held carrying device 700 according to this invention. As shown in FIG. 25, in this exemplary embodiment, the hand-held carrying device 700 comprises a held portion 710 and a mounting portion 720. The mounting portion 720 includes a portion 722 of the second connector 124. Thus, as shown in FIGS. 25 and 26, the touchpad or other control/input device 110 can be easily connected to the hand-held carrying device 700 by attaching the first connector 124 to the portion 722 of the second connector 124. Then, as shown in FIG. 26, the user can easily use the touchpad or other control/input device 110 as it is supported on the mounting portion 720 while comfortably holding the held portion 710 of the hand-held carrying device 700. FIGS. 27 and 28 are perspective views of the first exemplary embodiment of the hand-held carrying device 700 illustrating that the mounting portion 720 can be placed into different configurations or orientations relative to the held portion 710.

In some exemplary embodiments according to this invention, a joystick and/or other game or gaming controls can be incorporated onto the keyboard using one or more of the mounting devices according to this invention

In some exemplary embodiments, auxiliary or secondary keyboards with other key functions like numbers, Internet and/or multimedia hotkeys can be mounted to a keyboard using one or more mounting structures according to this invention. In some exemplary embodiments, by using one or more mounting structures according to this invention, deploying additional keyboards becomes simple. As outlined above in FIGS. 18-23, in some exemplary embodiments according to this invention, additional keyboards, touchpads, writing pads and/or the like may be hingedly mounted using one or more mounting structures according to this invention to allow the user to flip such devices between a usable position and an out of the way position.

In various exemplary embodiments of the split keyboard disclosed in the incorporated 918 application (published as U.S. Published Patent Application 2006/0274045), the left and right hand devices are both stationary, i.e., are used without moving them relative to the user's legs). In some such exemplary embodiments, one or both of these the left and right hand devices might have one or more control/input devices, such as a touchpad, an infrared sensor, a camera and/or the like to sense movement, and/or any other known or later developed control/input device, mounted to them using one or more mounting structures according to this invention.

It should be appreciated that, in some exemplary embodiments of the split keyboard disclosed in the incorporated 918 application, the split keyboard is gripped by slipping a thumb, finger, fingers, hand, wrist, and/or portion of an arm into, onto or around a form/forms or a bowling ball type grip and or a honeycomb type grip, slot/groove/pocket. This grip may have several different openings that allow the hand control of movement of the device and or the pointing operation of a built in computer mouse. This allows the hand to grip from different positions or angles, reducing, and ideally minimizing, repetitive stress related problems, as well as accommodating different hand sizes. Gripping areas may be as simple as a small panel that a finger/thumb etc. . . . may ride against. These forms or grips may be adjustable, having the ability to slide or be moved into different angles, positions, or directions allowing them to better accommodate different hand shapes and sizes. These grips or forms may also be used to lift, carry and or move device.

In some exemplary embodiments according to this invention, the user is able to choose which control/input devices and/or other desired components the user wants to include or implement. Because various control/input devices and/or other desired components are easily mixed and matched using mounting structures according to this invention, the user has the option to add additional control/input devices and/or other components in the future. For example, one user may want a mouse or touchpad on both left and right hand sides of a keyboard, while another user may choose not to have a mouse at all, knowing that it can always be added later if necessary or desirable.

In some exemplary embodiments according to this invention, all components including frame, mouse, keyboard, handles, forms, buttons etc. are supplied separately to the user. This allows the user to assemble and disassemble various components or be able to replace broken or worn parts as desired. In some exemplary embodiments according to this invention, mounting structures according to this invention allow the keyboard to accept aftermarket components, allowing the user to switch out and use different manufacturers' equipment with the keyboard as desired.

It should be appreciated that, in some exemplary embodiments, one or more mounting structures according to this invention can be attached or connected to one or more keyboard devices to position one or more control/input devices at positions desired by the user. Such control/input devices may include, but are not limited to, touchpads, pointers, mice, trackballs, scroll wheels, buttons, number pads, keypads, tablets, or other devices, each of which can be used in place of a mouse or incorporated along with the mouse. By positioning such control/input devices in different places, the user is able to minimize the distance that the user's hands have to move to operate pointing, clicking, scrolling, and similar functions. In some cases, users may operate such control/input without having to move their hands from the typing position.

Mounting structures according to this invention can be also enable people who are left handed to use equipment made for right-handed people, and vice versa. Multiple mounting structures according to this invention may be used with multiple control/input devices to provide more functionality for the user than would be available with a conventional input device arrangement (e.g., a standard keyboard and mouse). For example, mounting structures according to this invention allow the simultaneous use of multiple control/input devices that are optimized for different and/or specialized functions (e.g., different cursor tracking speeds or types of movements). In other exemplary embodiments, multiple identical control/input devices may be used to provide redundancy and to allow different hand and finger movements to accomplish the same functions (e.g., to prevent repetitive stress injuries).

In various exemplary embodiments according to this invention, the location, positioning and/or arrangement of control/input devices is fully customizable to optimize both comfort and functionality for the user. Mounting structures according to this invention allow a wide variety of options for the placement and movement of a user's hands, for convenience, comfort, efficiency, enhanced functionality, reduction of repetitive stress problems, and the opportunity to experiment with different configurations of control/input devices. Unlike currently available keyboard products that feature a single, fixed, stationary input device (such as a touchpad, trackball, scroll wheel, tablet, etc.), usually at the base of the keyboard, mounting structures according to this invention allows the user to position one or more control/input devices in dozens of different places in, on, and around one or more keyboard devices. The systems, devices and methods according to this invention also improve upon aftermarket standalone control/input devices, such as touchpads, since such devices typically have larger housings that make using the placement options, enabled when using one or more mounting structures according to this invention, with such aftermarket standalone control/input devices impractical and inefficient.

In some exemplary embodiments according to this invention, one or more input devices (e.g., touchpads, trackballs, scroll wheels, tablets, pointers, etc.) may be moved, rearranged, and/or detached from one or more additional input devices (e.g., keyboards, other input devices, etc.) while in use. In other exemplary embodiments according to this invention, one or more input device platforms are attached to a keyboard using plates that fit in between keys. In various exemplary embodiments according to this invention, the plate(s) and/or platform(s) are hinged, slideable, and/or movable to allow the platform and the supported input device to be rotated, slid, and/or moved into a different position (e.g., for ergonomic reasons, or to allow access to keys underneath). In some exemplary embodiments according to this invention, one or more mechanisms such as drawer slides, swiveling or rolling mechanisms, or rotating mechanism (e.g., lazy susans) are used to attach one or more platforms to a keyboard. In still other exemplary embodiments according to this invention, such moveable platforms have a means or mechanism for preventing movements or locking them in place, thus keeping the platforms in a stationary position unless movement or repositioning is desired. In yet other exemplary embodiments according to this invention, the platforms have a locking means or mechanism that is easily engaged and/or disengaged (e.g., by applying pressure, pressing a button, activating a switch, bending a ridge between keys, etc.). In some exemplary embodiments according to this invention, a cushioning means (e.g., one or more pads, etc.) are positioned to cushion an input device or platform as it is repositioned, so as to prevent damage to the input device, platform, keyboard housing, and/or any associated equipment. In some exemplary embodiments according to this invention, one or more input devices and/or one or more platforms are built into a keyboard housing. In various exemplary embodiments according to this invention, a wrist rest may be integrated into an input device, a platform, or a keyboard housing.

In yet other exemplary embodiments, the size and shape of the mounting structure according to this invention may be adjustable. This allows, for example, the mounting structure to straddle or be positioned on different surfaces or keyboards that have different shapes, differently spaced key rows, or different buttons for various media or scrolling functions. In some exemplary embodiments, the mounting structure has adjustments or sections that extend or retract vertically and/or horizontally. In other exemplary embodiments, different mounting structures may be optimized for use with different keyboards.

In some exemplary embodiments, a control/input device and/or a mounting structure according to this invention are attached with brackets, hinges, tape, glue, tacks, screws, Velcro, adhesive material, and/or any other appropriate known or later-developed fastening mechanism to a surface (e.g., back, front, sides, top, bottom, etc.) of a keyboard or other appropriate input device. In other exemplary embodiments, the control/input device and/or mounting structure according to this invention are attached with Velcro and are at least temporarily stationary on any available space. In some exemplary embodiments, the control/input device and/or mounting structure according to this invention are fastened permanently (e.g., via glue, etc.). In some exemplary embodiments, the control/input device and/or mounting structure according to this invention have a fixed or detachable pad (e.g., foam) on its underside, to help prevent undesired movement while in use. In other exemplary embodiments, a control/input device and/or mounting structure according to this invention are attached with an adjustable mechanism, such as a boom arm. In yet other exemplary embodiments, a control/input device and/or mounting structure according to this invention are attached via a surface material inserted through the hinge between a laptop computer and its screen portion. The surface material may be secured to the laptop computer to prevent movement.

In some exemplary embodiments, one or more mounting structures according to this invention may be positioned on, in, and/or around one or more keyboard housings and/or other appropriate input devices to allow items other than control/input devices to be placed within easy reach of the user. This arrangement enhances the overall ergonomic efficiency and convenience of the user experience. In other exemplary embodiments, the mounting structure according to this invention, control/input device, and/or keyboard housing are configured to accommodate storage, routing, connection, and repositioning of cables and/or cords. In yet other exemplary embodiments, the mounting structure according to this invention has a device or mechanism for connecting the mounting structure to one or more additional mounting structures, to expand the surface area available to the user.

In some exemplary embodiments, the keyboard touch pad is made of flexible silicone. In other exemplary embodiments, the keyboard touch pad or other components are made of plastic. In still other exemplary embodiments, the keyboard touch pad is made of fabric or is a virtual keyboard touch pad that is projected.

In some exemplary embodiments, the control/input device according to this invention is connected to a computer or other device using one or more standard interface protocols such as USB, PS/2, IEEE-1394, serial, parallel, or wireless connections. In other embodiments, the control/input device according to this invention is connected using any suitable wired or wireless connection protocol.

In some exemplary embodiments, the control/input device according to this invention has one or more auxiliary ports (e.g., USB, PS/2, IEEE-1394, serial, parallel, etc.) allowing the user to easily switch components and easily connect auxiliary control/input devices (e.g., flash drives, MP3 players, cameras, etc.). In some exemplary embodiments, one or more auxiliary ports use one or more standard interface protocols such as USB, PS/2, IEEE-1394, serial, parallel, or wireless connections (e.g., a wireless repeater or amplifier port). In other exemplary embodiments, the auxiliary ports use any suitable wired or wireless connection protocol.

In various exemplary embodiments, by combining the mouse and keyboard into a single unit, the user is able to switch between typing and using the mouse. This can be accomplished by, for example, simply dropping the palm of the user's hand on the top of a control panel, button, or other component that triggers a mouse click or other desired control feature. Taking away the need to reach for a mouse helps to reduce, and ideally eliminate, repetitive stress injuries related to mouse use.

In some exemplary embodiments, pressing down the palm area of the mouse form activates the left click function of the mouse. This palm-activated switch may be pressure sensitive allowing the palm to rest on it without triggering it and allowing a slight intentional movement of the palm to trigger the switch. In some exemplary embodiments, the mouse detaches from keyboard section. In some exemplary embodiments, either a left- or right-hand mouse is provided with an on/off switch and/or is able to make adjustments for a speed of the motion sensor. In some exemplary embodiments, the height and or angle of the mouse can be adjusted.

In some exemplary embodiments, the mouse is activated by pressing down on a form that engages it. A traditional mouse must be physically grasped and lifted in order to reposition it without moving the cursor.

In some exemplary embodiments, a button is position near and/or along the side of the keyboard to allow a user's thumb to activate the button while the user's hand is in a typing position or substantially in a typing position. The button may be used as a standard “right-click” or “left-click” mouse function or any other desired function. In some exemplary embodiments, two or more such buttons are provided, for example, on separate split keyboard components.

It should be understood that various exemplary embodiments of the computer control and/or input and mounting devices according to this invention are not limited to traditional computer keyboard, mouse and/or touchpad functions, and that any shape, size, quantity, or configuration of computer control and/or input devices and/or components may be used. For example, in some embodiments, the devices enable consumer-service like credit card magnetic strip reading, military applications, operation in automobile, aircraft, boat and/or other vehicles, etc. In various exemplary embodiments, the computer control and/or input devices and/or components according to this invention do not necessarily provide keyboard functions. Rather, in some exemplary embodiments, the computer control and/or input devices and/or components according to this invention provide one or more mouse functions and/or other known or later-developed computer peripheral functions.

Various exemplary embodiments of the computer control and/or input and mounting systems, devices and methods according to this invention find use in any application where-ever a computer keyboard or other peripheral is used. However, in various exemplary embodiments, the computer control and/or input and mounting systems, devices and methods according to this invention provides for improved ergonomic uses with people or in situations where improved ergonomic use is desired. For example, the computer control and/or input and mounting systems, devices and methods according to this invention are very useful to people who work in environments that have temporary furniture, like card tables or display tables (e.g., convention or production companies on location). Temporary office help that is constantly made to use different furniture will find the computer control and/or input and mounting systems, devices and methods according to this invention particularly useful. Various exemplary embodiments of the computer control and/or input and mounting systems, devices and methods according to this invention also will be particularly useful by police officers, pilots, or other persons who use a computer in a vehicle.

It should be appreciated that, as shown with respect to several exemplary embodiments described above, positioning the touchpad or other control/input device 110 on the function keys, or “Fkeys”, which are located just above the typing hand, is an efficient way to provide quickly-accomplishable cursor movement, A computer user often has to move the cursor only a fraction of an inch on the display screen of the computer, for example, to move the cursor from blocking the user's view of a word the user is typing. When using the repositionable ergonomic computer control and/or input systems, devices and methods according to this invention. the user can complete that cursor movement task and return to typing in about one second. In contrast, when using a traditionally-located mouse, it typically takes the user 3 to 4 seconds to reach and use a mouse, and additional time to return both of the user's hands to the keyboard and to resume typing. Using the repositionable ergonomic computer control and/or input systems, devices and methods according to this invention also requires less energy by the user to complete the task and helps to break up some of the repetitive motions that lead to repetitive stress injury.

It should be appreciated that, most, if not all, conventional touchpads currently available on the market include a plastic housing that surrounds the active control surface. This housing makes those conventional touchpads much thicker and wider than they need to be. In contrast, the touchpad or other control/input device according to this invention has only a skin tight covering and one component of a 2-component attachment structure on its back side. That is, no housing or any other bulky structure is provided on the sides of the touchpad or other control/input device according to this invention. Consequently, the touchpad or other control/input device according to this invention has a substantially smaller, thinner form factor. Therefore, the touchpad or other control/input device according to this invention, and thus the repositionable ergonomic computer control and/or input devices according to this invention are able to more efficiently work in very tight spots, such as when they are attached to a computer keyboard and provide a more ergonomic environment for the user.

In some exemplary embodiments, spacers are used to even out the back surface of or other control/input device according to this invention. Typically, the spaces will be located within the skin tight covering. This provides a more useful surface for the first component of the 2-component attachment structure that is placed on the back side of the touchpad or other control/input device according to this invention. For example, in various exemplary embodiments, the touchpad 110 includes a circuit board that is attached to the back side of the touch sensor of the touchpad 110. This circuit board is often uneven, such that, when placed and attached to the touch sensor, it is crooked or at an angle to the touch sensor, instead of laying flat. The spacers, if used, reduce the effects of this unevenness.

By placing one or more or spacers adjacent to the backside of the touch sensor or other active structure, between the circuit board and the skin-tight covering, the back surface of the touchpad according to this invention is generally made flat. It should be appreciated that the spacers can be formed using any appropriate material, including foam tape, and are desirably no thicker than necessary to even out unevenness of the back surface of the touchpad or other control/input device according to this invention. This tends to keep the touchpad or other control/input device according to this invention as thin as possible.

It should be appreciated that the skin-tight covering can be formed using any known or later-developed cover material, including common plastic casing, that is able to cap off the backside and or sides of the circuit board of the touchpad or other control/input device according to this invention. This tends to keep the touchpad or other control/input device according to this invention sealed and, when the spacers are also used, its back surface flat. It should further be appreciated that neither the size and/or the shape of the touchpad or other control/input device according to this invention is limited to those exemplary embodiments illustrated and described herein. For example, one touchpad or other control/input device according to this invention may be as small as a postage stamp, while another touchpad or other control/input device according to this invention as large as a sheet of legal paper.

Certain exemplary embodiments of computer control and/or input and/or mounting systems, devices and methods according to this invention are shown in the attached drawings and have been described above. It should be understood that the computer control and/or input and/or mounting systems, devices and methods according to this invention are not limited to these particular embodiments.

Thus, while this invention has been described in conjunction with the exemplary embodiments outlined above, various alternatives, modifications, variations, improvements and/or substantial equivalents, whether known or that are or may be presently foreseen, may become apparent to those having at least ordinary skill in the art. Accordingly, the exemplary embodiments of the invention, as set forth above, are intended to be illustrative, not limiting. Various changes may be made without departing from the spirit or scope of the invention. Therefore, the invention is intended to embrace all known or earlier developed alternatives, modifications, variations, improvements and/or substantial equivalents.

It should be understood that the examples and embodiments described herein are for illustrative purposes only and that various modifications or changes in light of these examples and embodiments will be apparent to those persons skilled in the art and are included within the spirit and purview of the following claims.

I claim:

1. A repositionable ergonomic computer control and/or input device usable with a computer having a keyboard, comprising:
a control/input device;
a first element of a 2-element connector provided on the control/input device; and
a mounting device including a second element of the 2-element connector, the mounting device usable to stably position the control/input device relative to the keyboard.

2. The repositionable ergonomic computer control and/or input device according to claim 1, wherein the mounting device further includes a pad of material, the pad having at least one surface having at least one of a high-friction and a high-surface energy, such that, when placed on a surface, the pad does not readily move upon use of the control/input device.

3. The repositionable ergonomic computer control and/or input device according to claim 1, wherein the mounting device is a layer of adhesive on a surface of the second element of the 2-element connector.

4. The repositionable ergonomic computer control and/or input device according to claim 1, wherein 2-element connector is a hook-and-loop connector comprising a hook element and a loop element.

5. The repositionable ergonomic computer control and/or input device according to claim 4, wherein one of the first and second elements is the hook element and the other of the first and second elements in the loop element.
